(19) United States
(12) Patent Application Publication
(10) Pub. No.: US 2026/0330772 A1
(43) Pub. Date: Oct. 22, 2026

(54) SERVER DEVICE AND VISITOR TERMINAL

(71) Applicant: Assembler, Inc., Tokorozawa-shi (JP)

(72) Inventor: Yasuyuki OTA, Tokorozawa-shi (JP)

(21) Appl. No.: 19/697,573

(22) Filed: Jun. 4, 2026

Related U.S. Application Data
(63) Continuation of application No. PCT/JP2024/043325, filed on Dec. 7, 2024.

(30) Foreign Application Priority Data
Dec. 7, 2023 (JP) 2023-207268

(51) Int. Cl. G06T 19/00; G01S 17/89

(52) U.S. Cl. CPC G06T 19/00; G01S 17/89; G06T 2219/024

(57) ABSTRACT

A server device for updating spatial data of a virtual space having coordinates corresponding to a real space based on image information obtained from a user terminal of a visitor in a real space acquiring time information and position information. The server device includes: a site information acquisition unit configured to acquire site information comprising spatiotemporal information, image information 8a corresponding to the spatiotemporal information and distance information to a target object corresponding to the image information; and an update unit configured to update the spatial data based on the site information. The site information can become an extremely large amount of data. The immediacy of the generation/updating of the virtual space is ensured by controlling the depth of the imaging data, in accordance with limitations imposed by the computational capability of the server device and the communication volume from the site location to the server device.

### CROSS-REFERENCE TO RELATED APPLICATIONS

This Application claims the benefit of priority and is a Continuation application of the prior International Patent Application No. PCT/JP2024/043325, with an international filing date of Dec. 7, 2024, which designated the United States, and is related to the Japanese Patent Application No. 2023-207268, filed Dec. 7, 2023, the entire disclosures of all applications are expressly incorporated by reference in their entirety herein.

### TECHNICAL FIELD

The present invention relates to spatial data of a virtual space for enabling a visitor visiting a real space and a virtual visitor visiting a virtual space to interact with each other via the virtual space.

### BACKGROUND OF THE INVENTION

In recent years, many technologies using the virtual space have been developed. These technologies provide users with new experiences through the virtual space. Furthermore, for example, a technology known as a digital twin acquires information about a real space, reproduces the environment of the real space to construct a virtual space paired with the real world.

Patent Document 1 discloses a server device used in a communication method via a virtual-space farm and a real farm. The server device includes: a person information acquisition means for acquiring pre-registered person information based on identification information for identifying a visitor to the farm or a virtual visitor to the virtual-space farm; a virtual space processing means for transmitting a viewpoint image of movement through the virtual-space farm based on operations by the virtual visitor to a user terminal of the virtual visitor; and a coordinate acquisition means for acquiring position information of the visitor so as to transmit the information to the user terminal of the virtual visitor visiting the virtual-space farm. The virtual space processing means displays a pre-set avatar display element of the visitor at a coordinate position in the virtual-space farm corresponding to the position information.

### PRIOR ART DOCUMENT

### Patent Documents

[Patent Document 1] Japanese Patent No.7300220

### SUMMARY OF THE INVENTION

### Problem to be Solved by the Invention

In the digital twin, since the virtual space paired with the real space exists, it is desirable to incorporate changes over time in the real space into the virtual space. For example, in a virtual farm or virtual event space, if a visitor to the real space and a virtual visitor to the virtual space can simultaneously share the same or similar experience within the same or similar scenery, the empathy between the two can be fostered. However, incorporating all changes in the real space into the virtual space is cumbersome. There are limits to the processing speed of the server device for computation, and there are limits to the amount of data that can be communicated per unit time.

Accordingly, an object of the present invention is to provide a method for updating spatial data of a virtual space in which a visitor to a real space and a virtual visitor to a virtual space interact with each other via the virtual space, a server device for updating spatial data of a virtual space, and a system for updating spatial data of a virtual space.

### Means for Solving the Problems

(1) A method for updating a virtual space of the present invention is a method for updating a virtual space for updating spatial data of the virtual space having coordinates corresponding to positions in a real space, the method being executed by a server device and a visitor terminal, the server device including an update unit, the visitor terminal being held by a visitor visiting an event area in the real space and including a position information acquisition unit, an image information acquisition unit and a distance information acquisition unit, wherein the visitor terminal is communicably connected to a virtual visitor terminal held by a virtual visitor visiting the virtual space and an updated event area of the virtual space is displayed on a display unit of the virtual visitor terminal, the method comprising: a step of acquiring, by the visitor terminal, site information comprising: spatiotemporal information including time information and position information acquired by the position information acquisition unit; image information corresponding to the spatiotemporal information acquired by the image information acquisition unit; and distance information from the visitor terminal to a target object corresponding to the image information acquired by the distance information acquisition unit; and a step of updating, by the update unit, the spatial data corresponding to the site information based on the site information among the spatial data.

(2) In the above described method for updating the virtual space, it is preferred that the distance information acquisition unit is configured to acquire the distance information using a LiDAR sensor.

(3) Furthermore, it is preferred that the server device includes a determination unit, the determination unit is configured to perform a step of determining whether or not there is a difference between the spatial data corresponding to the site information and an existing spatial data, and a portion of the existing spatial data having the difference is updated when the difference exists.

(4) A method for updating a virtual space of another aspect of the present invention is a method for updating a virtual space for updating spatial data of the virtual space having coordinates corresponding to positions in a real space, the method being executed by a server device and a visitor terminal, the server device including an update unit and an adjustment unit, the visitor terminal being held by a visitor in the real space and including a position information acquisition unit, an image information acquisition unit and a distance information acquisition unit, the method comprising: a step of acquiring, by the visitor terminal, site information comprising: spatiotemporal information including time information and position information acquired by the position information acquisition unit; image information corresponding to the spatiotemporal information acquired by the image information acquisition unit; and distance information from the visitor terminal to a target object corresponding to the image information acquired by the distance information acquisition unit; a step of updating, by the update unit, the spatial data based on the site information; and a step of making, prior to the step of acquiring the site information, by the adjustment unit, an adjustment to reduce a distance to be acquired by the distance information acquisition unit and/or a range over which the distance information is acquired when processing information relating to a processing speed of the server device and/or communication information relating to a communication speed between the server device and the visitor terminal decreases.

(5) Furthermore, it is preferred that the spatial data is updated at predetermined time intervals by a surrounding camera installed in the real space.

(6) Furthermore, it is preferred that the surrounding camera updates the spatial data using a LiDAR sensor.

(7) A server device of another aspect of the present invention is a server device for updating spatial data of a virtual space having coordinates corresponding to positions in a real space, the server device comprising: a site information acquisition unit configured to acquire site information obtained from a visitor terminal held by a visitor in an event area of the real space, the site information comprising spatiotemporal information including time information and position information; image information corresponding to the spatiotemporal information; and distance information from the visitor terminal to a target object corresponding to the image information; and an update unit configured to update the spatial data corresponding to the site information based on the site information among the spatial data, wherein the visitor terminal is communicably connected to a virtual visitor terminal held by a virtual visitor visiting the virtual space and an updated event area of the virtual space is displayed on a display unit of the virtual visitor terminal.

(8) In the above described server device, it is preferred that the distance information is acquired using a LiDAR sensor.

(9) Furthermore, it is preferred that a determination unit configured to determine whether or not there is a difference between the spatial data corresponding to the site information and an existing spatial data is further provided, wherein a portion of the existing spatial data having the difference is updated when the difference exists.

(10) A server device of another aspect of the present invention is a server device for updating spatial data of a virtual space having coordinates corresponding to positions in a real space, the server device comprising: a site information acquisition unit configured to acquire site information obtained from a visitor terminal held by a visitor in the real space, the site information comprising: spatiotemporal information including time information and position information; image information corresponding to the spatiotemporal information; and distance information from the visitor terminal to a target object corresponding to the image information; an update unit configured to update the spatial data based on the site information; and an adjustment unit configured to make an adjustment to reduce the distance to be acquired and/or a range over which the distance information is acquired when processing information relating to a processing speed of the server device and/or communication information relating to a communication speed with the visitor terminal decreases.

(11) Furthermore, it is preferred that the spatial data is updated at predetermined time intervals by a surrounding camera installed in the real space.

(12) Furthermore, it is preferred that the surrounding camera updates the spatial data using a LiDAR sensor.

(13) A system of another aspect of the present invention is a system for updating spatial data of a virtual space having coordinates corresponding to positions in a real space, the system comprising: a server device; a visitor terminal held by a visitor visiting an event area in the real space; and a virtual visitor terminal held by a virtual visitor visiting the virtual space, wherein the visitor terminal includes: a position information acquisition unit configured to acquire spatiotemporal information comprising time information and position information; an image information acquisition unit configured to acquire image information corresponding to the spatiotemporal information; and a distance information acquisition unit configured to acquire distance information from the visitor terminal of the visitor to a target object corresponding to the image information, the server device includes an update unit configured to update the spatial data corresponding to the site information comprising: the spatiotemporal information; the image information; and the distance information based on the site information among the spatial data, and the virtual visitor terminal is communicably connected to the visitor terminal and includes a display unit that displays an updated event area of the virtual space.

(14) A visitor terminal of another aspect of the present invention is a visitor terminal for updating spatial data of a virtual space having coordinates corresponding to positions in a real space, the visitor terminal being held by a visitor in an event area of the real space, the visitor device comprising: a site information acquisition unit configured to acquire site information, the site information comprising: spatiotemporal information including time information and position information; image information corresponding to the spatiotemporal information; and distance information from the visitor terminal to a target object corresponding to the image information; and an update unit configured to update the spatial data corresponding to the site information based on the site information among the spatial data, wherein an updated event area of the virtual space is displayed on a display unit of a virtual visitor terminal held by a virtual visitor visiting the virtual space.

(15) A visitor terminal of another aspect of the present invention is a visitor terminal for updating spatial data of a virtual space having coordinates corresponding to positions in a real space, the visitor device comprising: a site information acquisition unit configured to acquire site information, the site information comprising: spatiotemporal information including time information and position information; image information corresponding to the spatiotemporal information; and distance information to a target object corresponding to the image information; an update unit configured to update the spatial data based on the site information; and an adjustment unit configured to make an adjustment to reduce a distance to be acquired and/or a range over which the distance information is acquired when processing information relating to a processing speed of the server device and/or communication information relating to a communication speed with the visitor terminal held by a virtual visitor visiting the virtual space decreases.

(16) The visitor terminal according to (14) is preferred to further comprise: an adjustment unit configured to make an adjustment to reduce a distance to be acquired and/or a range over which the distance information is acquired based on a mode selection by an operation of a user of the visitor terminal, a start of a call between the visitor and the virtual visitor, a decrease in processing information relating to a processing speed of the visitor terminal, or a decrease in communication information relating to a communication speed with the virtual visitor terminal.

(17) The visitor terminal according to (15) is preferred that the adjustment unit is configured to make the adjustment to reduce the distance to be acquired and/or the range in which the distance information is acquired also based on a mode selection by an operation of a user of the visitor terminal or a start of a call between the visitor and the virtual visitor.
“position information” refers to the information relating to the position of a visitor visiting an actual event area within the event area. For example, “position information” is a concept including coordinates indicating a two-dimensional or three-dimensional point, coordinates indicating a predetermined range such as a plane or a space and quantities convertible to the above described coordinates. For example, “position information” may be the information expressed in terms of latitude and longitude, or the information further expressed with the addition of altitude. Furthermore, “position information” may be the information expressed in another index value convertible to the latitude, the longitude and the altitude, for example.

When the place visited is a farm, “position information” refers to the information relating to the position of a visitor visiting the actual farm within the farm, and is a concept including, for example, coordinates indicating a two-dimensional or three-dimensional point, coordinates indicating a predetermined range such as a plane or a space and quantities convertible to the above described coordinates.
“time information” refers to the information indicating the time at which the position information was identified. In addition, “time information” may be a time in Japan, a time in a foreign country or an elapsed time relative to a reference time. Furthermore, “time information” may be the information expressed in another index value convertible to a time or an elapsed time relative to a reference time, for example.
“image information” refers to the data of images or videos captured by a user terminal, and is a concept including the data convertible to the above described data.
“distance information” refers to the information relating to the distance from a user terminal to a location captured in the image information, and is a concept including quantities convertible to the above described distance.
“coordinate position information” refers to the coordinates indicating a two-dimensional or three-dimensional point in a virtual space, or coordinates indicating a predetermined range such as a plane or a space, and is a concept including quantities convertible to the above described coordinates.
“processing information” refers to the processing information relating to the processing speed of a server device. The processing information is affected by the CPU performance of the server device, the available memory capacity, the read/write speed of the hard disk, the degree of congestion of the server device (number of users accommodated/load), the processing method of PHP (Hypertext Preprocessor) and the like.
“communication information” refers to the communication information relating to the communication speed between a server device and a user terminal.

### Effects of the Invention

The spatial data of the virtual space can be updated easily.

### BRIEF DESCRIPTION OF DRAWINGS

FIG. 1 is a schematic diagram showing an overview of a virtual space update system.

FIG. 2 is a functional block diagram showing the virtual space update system.

FIG. 3 is a schematic diagram showing display screens of user terminals of a visitor and a virtual visitor.

FIG. 4 is a schematic diagram showing an example of a hardware configuration of a server device.

FIG. 5 is a schematic diagram showing an example of a hardware configuration of a user terminal.

FIG. 6 is a schematic diagram showing an example of a hardware configuration of a head-mounted display unit.

FIG. 7 is a flowchart showing an embodiment of a flow of update processing.

FIG. 8 shows data structure of an adjustment amount database.

FIG. 9 is a schematic diagram showing differences in spatial data.

### DETAILED DESCRIPTION OF THE INVENTION

### 1. Overview

The virtual space update system according to the present embodiment reflects (updates) changes in a real space into spatial data of a virtual space in a digital twin environment. Rather than using pre-recorded spatial data, the system allows a virtual visitor to experience phenomena occurring in the real world at that moment with the assistance of a real visitor.

Specifically, the spatial data is updated based on the site information acquired from the user terminal of a visitor to the real space. The site information is spatiotemporal information (time information and position information), image information, and distance information from the user terminal to a target object in the image information. At that time, if everything is updated with the site information of the visitor, the amount of data and the amount of computation increase. For this reason, the depth and range of information to be updated are narrowed down. The degree of narrowing is adjusted according to the computational capability and communication speed of the server device and system respectively. Even if the amount of information is reduced, through the partial and continuous updating of the range to be updated by multiple visitors to the real space, a practical virtual space in the digital twin can be constructed by synthesizing the real-time nature of the necessary portion at hand of a virtual visitor with the overall general image of the entire space.

Furthermore, the site information that real-space visitors should pay attention to tends to concentrate at specific places and times. For this reason, the spatial data can be updated efficiently without updating all of the spatial data.

The virtual space update system is preferably applied to, for example, morning markets at tourist spots, fish unloaded from boats returning to a fishing port, open-air markets, antiques and secondhand clothing and sundry goods stores, and other settings where only the items on hand at that moment are available, or settings where the negotiation between seller and buyer such as in banana bargaining sales is itself valuable as an experience. In addition, the virtual visitor can experience phenomena such as auroras and blizzards as tourism.

### 2. Overview Explanation

### (Overview of Virtual Space Update System 10)

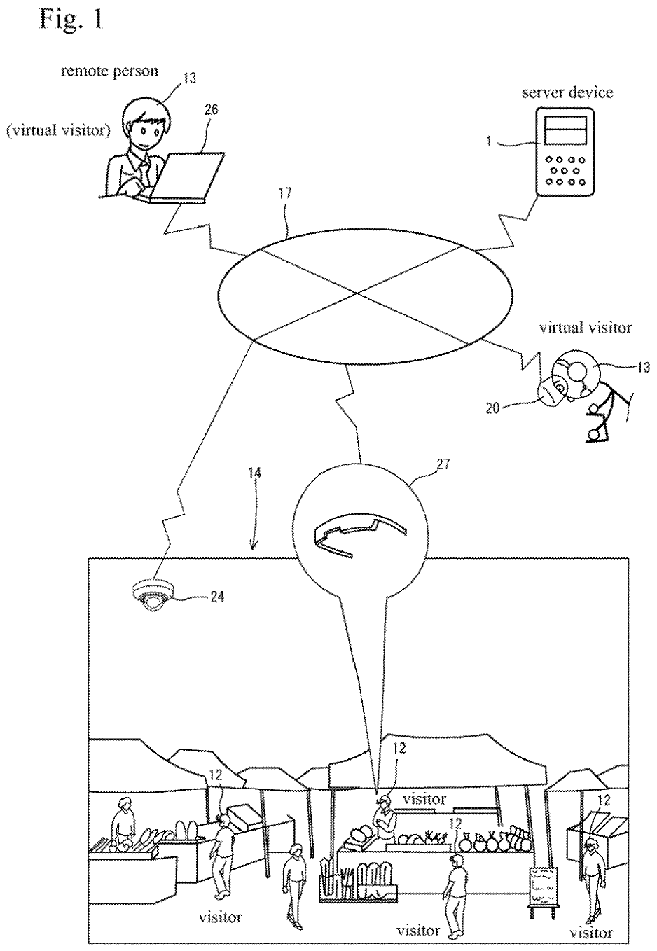

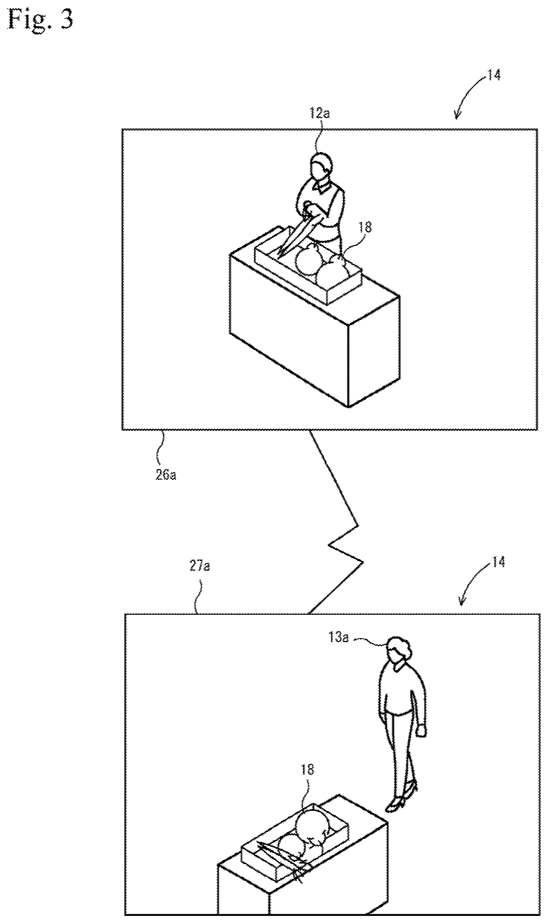

First, the overview of the virtual space update system will be explained with reference to FIG. 1. The virtual space update system (hereinafter referred to as “system”) 10 shown in FIG. 1 is mainly used between a visitor 12 visiting a market/morning market or the like (event area) 11 and a remote person 13 who is not visiting the event area 11, for example, a person at home. The remote person 13 includes the virtual visitor 13 who visits a virtual-space event area 14 (shown in FIG. 3) comprising three-dimensional spatial data of either an imaging space formed from imaging of the event area 11 or a simulated space formed by simulating the imaging.

The virtual visitor 13 visits the virtual-space event area 14, for example, to participate in an event, to exhibit at an event, to check or purchase event-related products 18, or to interact with other participants/exhibitors. The virtual visitor 13 can also interact with other virtual visitors 13 visiting the virtual-space event area 14.

The stores selling event-related products 18 include, for example, stores within the event area 11 or the virtual-space event area 14, and are a concept that includes roadside stations, local stores, department stores, supermarkets and convenience stores, as well as entities convertible to the above described stores.

### (Event Area 11)

The event area 11 is not particularly limited. For, example, the event area 11 includes event venues where specific events are held, and is an area for events held outdoors and/or indoors. Examples of the event venues include street corners, martial arts halls, exhibition halls, art museums, temples, churches, amusement parks, concert halls, gymnasiums, schools, auditoriums, baseball stadiums, athletic stadiums, parks, farms, ranches, care facilities and hospitals.

Examples of the events include expositions such as world expos, exhibitions, sales events, regional product fairs, conferences, concerts, theatrical performances, musical concerts, athletic meets, competitions, festivals, fireworks displays and tourism events. The tourism is also included in events.

Note that it is possible to link with event areas of other virtual spaces and travel between the other virtual spaces.

### (Virtual-Space Event Area 14)

The virtual-space event area 14 (shown in FIG. 3) is spatial data comprising three-dimensional spatial data of either an imaging space formed from imaging of the event area 11 or a simulated space computed and formed from the imaging and depth (distance information 9a).

### 3. Each Component

### (System 10)

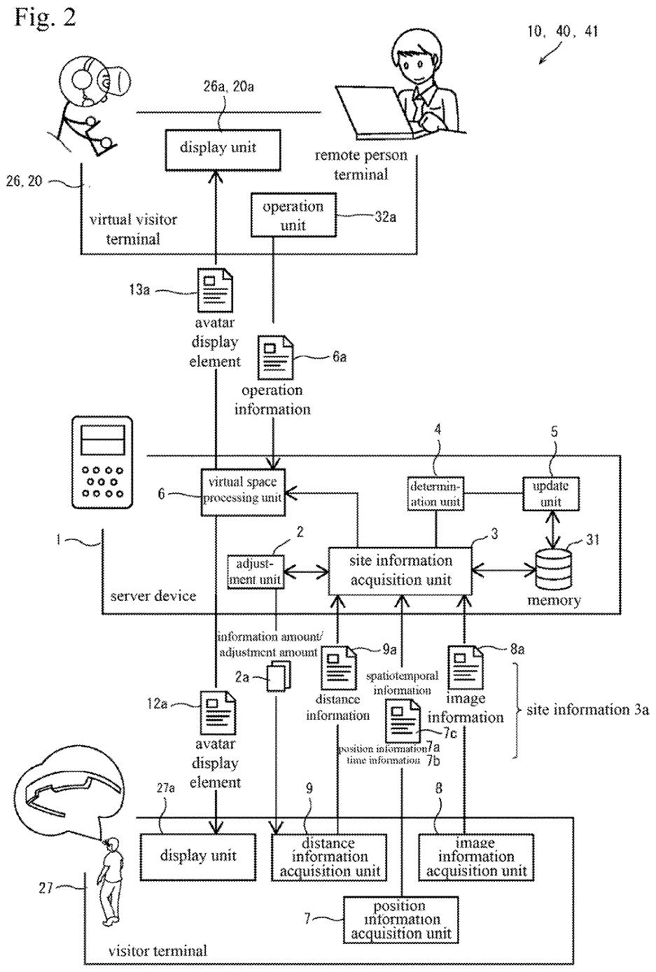

Next, the system 10 according to one embodiment of the present invention will be explained using the functional block diagram of FIG. 2.

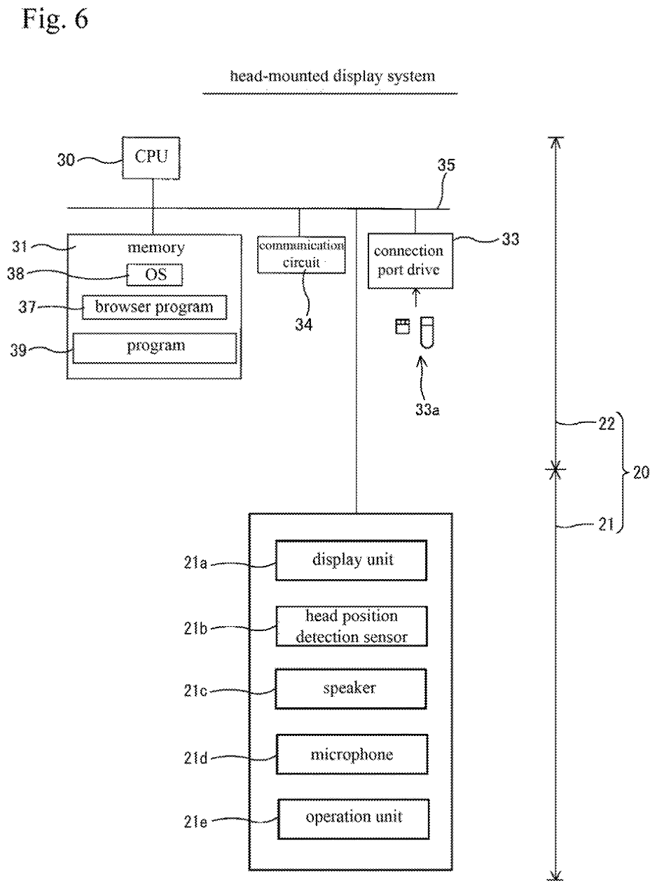

The system 10 includes a server device 1, a user terminal 26 held by the virtual visitor 13 (hereinafter referred to as “remote person terminal/virtual visitor terminal”), and a user terminal 27 held by the visitor 12 (hereinafter referred to as “visitor terminal”). The server device 1, the virtual visitor terminal 26 and the visitor terminal 27 are each communicably connected via a communication network 17 (shown in FIG. 1) such as the Internet (intranet). The reference numeral 20 denotes a head-mounted display system, which will be explained later (shown in FIG. 6).

Note that the remote person 13 can also interact with the visitor 12 via text information without visiting the virtual-space event area 14.

### (Server Device 1)

In the present embodiment, the server device 1 uses, for example, a personal computer. The server device 1 primarily includes an adjustment unit 2, a site information acquisition unit 3, a determination unit 4 and an update unit 5. The server device 1 further includes a virtual space processing unit 6.

### (Virtual Visitor Terminal 26)

In the present embodiment, the virtual visitor terminal 26 is, for example, a smartphone. The virtual visitor terminal 26 may also be a wearable computer that can be worn or attached to the body, a head-mounted display system, a mobile phone, a tablet terminal or a personal computer.

The virtual visitor terminal 26 (20) primarily includes a position information acquisition unit 7 and an image information acquisition unit 8. The virtual visitor terminal 26 (20) may further include a distance information acquisition unit 9.

The virtual visitor terminal 26 (20) includes a display unit 26a (20a). The reference numeral 20a denotes the display unit of the head-mounted display system (shown in FIG. 6). The virtual visitor terminal 26 (20) displays, as virtual reality (VR), an avatar display element of the visitor 12 on a viewpoint image of the virtual space. The virtual visitor terminal 26 also identifies the current position and orientation using, for example, a gyro sensor.

### (Visitor Terminal 27)

In the present embodiment, the visitor terminal 27 is substantially the same as the virtual visitor terminal 26 (20). Thus, the same reference numerals are assigned to the same parts and the explanation is omitted. In the present embodiment, the visitor 12 wears the visitor terminal 27 such as smart glasses or AR glasses. The visitor terminal 27, as augmented reality (AR), projects pre-registered avatar display elements as digital images onto the field of view of the real event area 11. The display unit 27a of the smart glasses or AR glasses is a portion that allows see-through viewing of the scenery while superimposing digital images.

### (Position Information Acquisition Unit 7)

The position information acquisition unit 7 has a function of acquiring position information 7a and time information 7b of the visitor terminal 27. For example, the position information acquisition unit 7 acquires the position information using a GPS (Global Positioning System) sensor. The positioning methods other than a GPS sensor may also be used, such as Wi-Fi positioning or beacon positioning. The indoor positions can be identified using Wi-Fi positioning or beacon positioning. Note that the position information 7a and the time information 7b constitute spatiotemporal information 7c.

### (Image Information Acquisition Unit 8)

The image information acquisition unit 8 is an imaging sensor such as an image sensor or an RGB sensor. For example, the image information acquisition unit 8 is a conventionally known device equipped with a CCD (Charge Coupled Device) image sensor, a CMOS (Complementary Metal Oxide Semiconductor) image sensor or the like. The imaging sensor receives, for example, ambient light with a photodiode to detect RGB values and obtain a color image.

The image information acquisition unit 8 generates image information 8a. The image information acquisition unit 8 may be incorporated into and integrated with the visitor terminal 27, or may be a separate unit from the visitor terminal 27. The image information acquisition unit 8 may also be equipped with a sound-collecting device (not illustrated) such as a microphone.

### (Distance Information Acquisition Unit 9)

The distance information acquisition unit 9 acquires the distance information 9a relating to the distance (depth) to a target object in the generated image information 8a. When receiving an information amount (adjustment amount) 2a from the adjustment unit 2, the distance information acquisition unit 9 shortens the search depth to reduce (decrease) the information amount 2a of the distance information 9a. The reduced information amount 2a may be restored to its original level.

Then, the reduced distance information 9a is transmitted to the server device 1. At this time, the image information 8a corresponding to the reduced distance information 9a is also reduced. As a result, the image information 8a and the distance information 9a with a short search depth, for example, on the near side are transmitted to the server device 1.

Note that the image information 8a that is not linked to the distance information 9a may also be transmitted to the server device 1.

Known techniques can be used for acquiring distance, such as a LiDAR (Light Detection and Ranging) sensor, an iToF (Indirect Time of Flight) sensor, a triangulation method using infrared light or the like. A stereo camera may also be used.

Furthermore, when Visual SLAM is used for acquiring spatial data 25 described later, the distance information 9a is acquired by the distance information acquisition unit 9 from two or more pieces of image information 8a. A plurality of pieces of image information 8a may be acquired from a plurality of visitor terminals 27, or may be acquired as image information 8a acquired by a single visitor terminal 27 at different positions. The plurality of pieces of image information 8a to be selected is preferably acquired within a predetermined range of time information 7b.

### (Spatial Data 25)

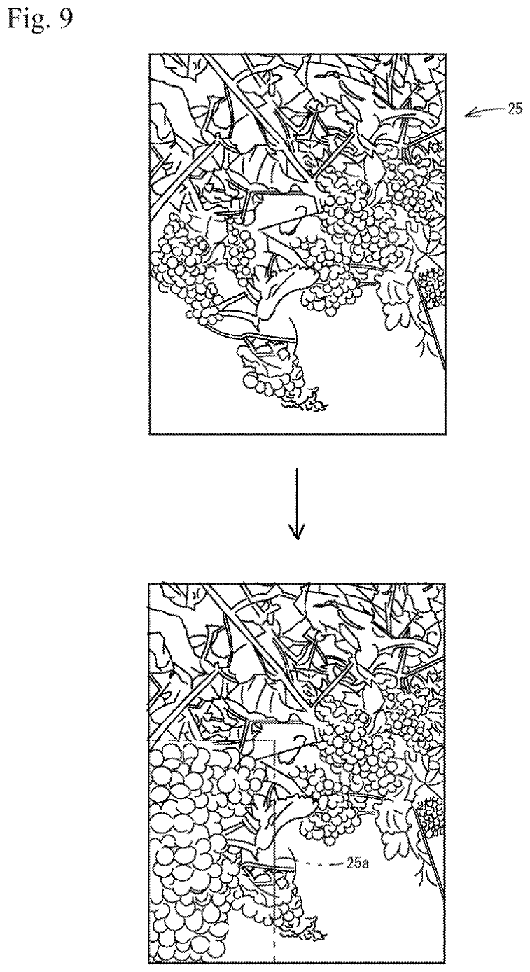

Known techniques can be used for acquiring the spatial data 25 (shown in FIG. 9) for updating. As one example, a technique called SLAM (Simultaneous Localization and Mapping) can be used. SLAM is a general term for a technology that simultaneously performs “self-localization” estimating where one currently is and “environment map creating” understanding the surrounding environment. Depending on the sensor mounted, SLAM includes Depth SLAM, Visual SLAM, LiDAR SLAM and others.

Existing spatial data before being updated is generated by a surrounding camera 24 (shown in FIG. 1) that collects two-dimensional/three-dimensional data.

### (Surrounding Camera 24)

The surrounding camera 24 generates three-dimensional data images, creates the virtual space to be displayed, and stores it in the storage unit 31 as spatial data. In the present embodiment, the surrounding camera 24 is fixedly installed in the event area 11. A plurality of surrounding cameras 24 may be installed. In the present embodiment, the surrounding camera 24 photographs the event area 11 at predetermined time intervals, for example, once a month, and updates the spatial data 25.

### (Adjustment Unit 2)

The adjustment unit 2 adjusts the information amount 2a (shown in FIG. 2) of the distance information 9a to be acquired, in accordance with the processing information relating to the processing speed of the server device 1 and/or the communication information relating to the communication speed between the server device 1 and the visitor terminal 27. The quantity may be an adjustment amount of the distance information acquisition unit 9 as a quantity convertible to the information amount 2a. The adjustment amount is, for example, the distance (depth) to be acquired by the distance information acquisition unit 9 and/or the range over which the distance information is acquired. The adjustment unit 2 transmits the information amount 2a to the visitor terminal 27.

Note that the site information acquisition unit 3 may delete excess information so as to achieve the adjusted information amount 2a to reduce the amount of computation in the server device 1.

### (Site Information Acquisition Unit 3)

The site information acquisition unit 3 acquires site information 3a comprising the spatiotemporal information 7c, the image information 8a corresponding to the spatiotemporal information 7c and the distance information 9a to the target object corresponding to the image information 8a. Next, the site information acquisition unit 3 aligns the spatial data based on the site information 3a with the existing spatial data 25. Known techniques can be used for the alignment. For example, the feature points may be extracted from the spatial data based on the site information 3a and the existing spatial data 25, and the coordinates of the respective spatial data may be matched based on the feature points. As one example, the extraction of the feature points is performed using, for example, the image information 8a to extract vertices of a rectangle.

The site information acquisition unit 3 also acquires the coordinate position (viewpoint coordinates) in three-dimensional space corresponding to the viewpoint image displayed on the virtual visitor terminal 26 (20). For example, in the present embodiment, based on the viewpoint coordinates, an avatar display element representing another virtual visitor 13 other than oneself is displayed on the display unit 26a (20a). Note that an avatar display element representing oneself may also be displayed on the display unit 26a (20a) of one's own terminal 26 (20).

### (Determination Unit 4)

The determination unit 4 determines whether or not there is a predetermined difference with respect to the spatial data 25 at the coordinates corresponding to the site information 3a. When a difference exists, the portion 25a of the spatial data 25 having the difference (shown in FIG. 9) is updated. On the other hand, when there is no difference, no update is performed. The determination is performed using known techniques. As one example, based on three-dimensional coordinate values (X, Y, Z) and/or color information (R, G, B) as point cloud data of the obtained site information 3a and the existing spatial data 25, it is determined whether there is a difference equal to or greater than a predetermined value in the three-dimensional coordinates and/or color information. For example, when there is a difference equal to or greater than a predetermined value in a plurality of values, it is determined that a difference exists. A predetermined range including the differing coordinates is defined as the differing portion 25a.

Alternatively, the portion 25a having a predetermined difference may be extracted from the spatial data generated from the site information 3a and the existing spatial data 25 using a machine learning model.

### (Update Unit 5)

The update unit 5 replaces/overwrites the differing portion 25a into the corresponding existing spatial data 25 to update it.

### (Virtual Space Processing Unit 6)

The virtual space processing unit 6 generates a virtual image to be displayed on the display unit 26a (20a) of the virtual visitor terminal 26 (20) based on operation information 6a relating to an operation amount output from the input/output device 32 (operation unit 32a) of the virtual visitor terminal 26 (20) (shown in FIG. 3). For example, in cooperation with the control device 22 of a head-mounted display system 20, the virtual space processing unit 6 performs generation of images and the like to be displayed on the display unit 20a and various computation processes.

### (Display Unit 26a, 27a, 20a)

As the display units 26a, 27a, 20a, devices for displaying images are used, such as a liquid crystal display (LCD: Liquid Crystal Display), a plasma display panel (PDP: Plasma Display Panel) and an organic EL (EL: Electroluminescence) display. A touch panel may also be provided on the display unit. The touch panel outputs a corresponding output signal in response to an operation by a user. By operating the touch panel, the user can perform operations such as selecting information displayed on the display units 26a, 27a, 20a.

FIG. 3 is a schematic diagram showing the display screens of the user terminals 27 and 26 of the visitor 12 and the virtual visitor 13 respectively. The avatar display elements 12a, 13a comprise, for example, two-dimensional or three-dimensional spatial data of either a captured image formed from imaging of the visitor 12 or virtual visitor 13, or a pseudo-image formed by simulating the imaging. Note that a preferred image unrelated to imaging may also be used as the avatar display element.

### (Avatar Display Element 12a of Visitor 12)

Specifically, the visitor terminal 27 acquires the position information 7a within the event area 11 based on GPS or indoor positioning technology, and transmits the position information 7a to the site information acquisition unit 3 of the server device 1. The virtual space processing unit 6 of the server device 1 converts the position information 7a into a coordinate position in the virtual space, and transmits the avatar display element 12a of the visitor 12 to be displayed at that coordinate position to the virtual visitor terminal 26 (20).

### (Avatar Display Element 13a of Remote Person (Virtual Visitor) 13)

On the other hand, the server device 1 acquires coordinate position information relating to the coordinate position of the virtual visitor 13 in the virtual space. The virtual space processing unit 6 transmits, to the visitor terminal 27, the pre-set avatar display element 13a of the virtual visitor to be displayed superimposed on the field of view through the visitor terminal 27 of the visitor 12, at the position of the event area 11 corresponding to the acquired coordinate position information.

### (Display Screen)

Next, the display screens of the virtual visitor terminal 26 (20) and the visitor terminal 27 will be explained with reference to FIG. 3. In the display screens shown in the figure, the upper portion shows the display screen of the display unit 26a of the virtual visitor terminal 26 (20), and the lower portion shows the display screen of the display unit 27a of the visitor terminal 27.

### (Display Screen of Display Unit 26a of Virtual Visitor Terminal)

The display screen of the virtual visitor terminal 26 (20) shows the virtual-space event area 14 comprising two-dimensional or three-dimensional spatial data of either an imaging space formed from imaging of the event area 11 or a simulated space formed by simulating the imaging. In the present embodiment, a virtual space comprising three-dimensional spatial data formed by imaging is displayed.

### (Display Screen of Display Unit 27a of Visitor Terminal)

The display screen of the display unit 27a of the visitor terminal 27 corresponds to the field of view of the visitor 12 captured by imaging of the event area 11 or transmitted through smart glasses or the like. The avatar display element 13a of the virtual visitor 13 is displayed on the display screen of the display unit 27a. The reference numeral 18 denotes agricultural products (event-related products).

The corresponding person or product can be selected by selecting the avatar display elements 12a, 13a using the input/output device 32 through user operation, or by touching the corresponding portion of the display unit with a finger.

### 3. Hardware Configuration

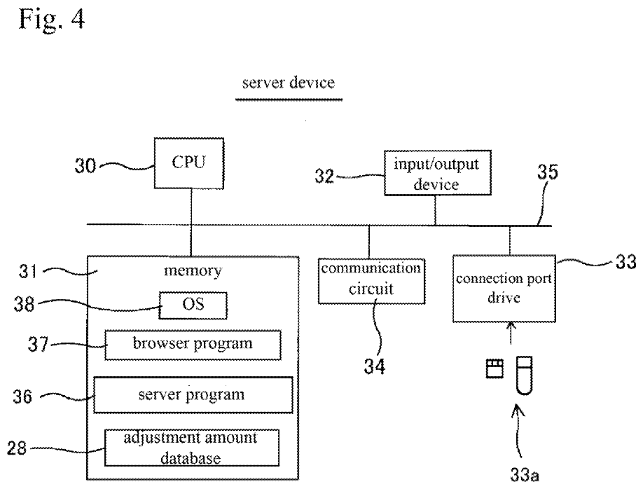

Next, the hardware configurations of the server device 1, the user terminals 26, 27 and the head-mounted display system 20 will be explained with reference to FIGS. 4, 5 and 6 respectively.

### (Hardware Configuration of Server Device 1)

As shown in FIG. 4, in the server device 1 of the present embodiment, a computer is used, for example.

The computer includes a CPU 30. A memory (hereinafter referred to as storage unit) 31, an input/output device 32 including a keyboard, a mouse and the like, a connection port 33 for connecting/reading a storage device 33a and the like, and a communication circuit 34 for communicating with the outside via a network are connected to the CPU 30 via a bus line 35. The storage unit 31 stores an adjustment amount database (adjustment amount DB) 28, site information 23, a server program 36 for processing the system 10, a browser program 37 and an OS 38 (operating system).

In the present embodiment, the server program 36 operates in cooperation with the functions of the OS 38 and the browser program 37. Note that the server program 36 may operate independently without using the browser program 37 or the OS 38. The server program 36 is stored, for example, in the storage device 33a. The server program 36 is installed in the server device 1 by reading the storage device 33a from the connection port 33.

### (Hardware Configuration of User Terminals 26, 27)

Next, the hardware configuration of the user terminals will be explained. The user terminals are used as the virtual visitor terminal 26 and the visitor terminal 27. Here, the hardware configuration of the virtual visitor terminal 26 will be explained, and the explanation of the visitor terminal 27 will be omitted.

The hardware configuration of the virtual visitor terminal 26 is substantially the same as the hardware configuration of the server device 1 described above. Thus, the same reference numerals are assigned to the same parts and the explanation is omitted.

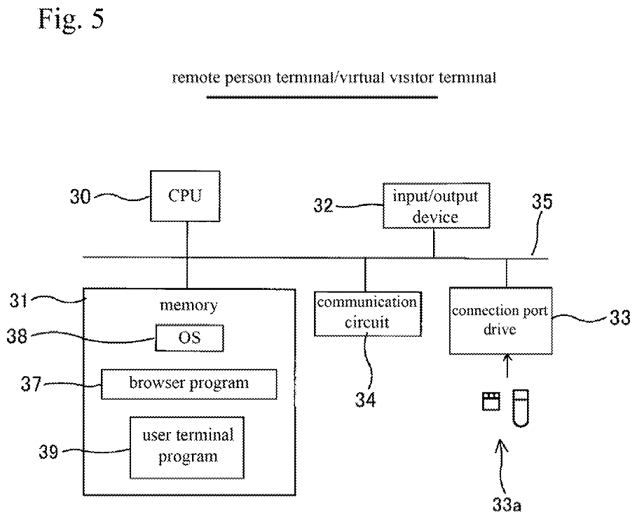

As shown in FIG. 5, in the virtual visitor terminal 26 of the present embodiment, for example, a smartphone, a laptop computer, a head-mounted display system or the like may be used.

The virtual visitor terminal 26 includes a CPU 30. A storage unit 31, a connection port 33 for connecting/reading a storage device 33a and the like, and a communication circuit 34 for communicating with the outside via a network are connected to the CPU 30 via a bus line 35. The input/output device 32 includes, for example, a microphone, a speaker and an operation unit 32a. The microphone, the speaker and the operation unit 32a are the same as the corresponding parts of the head-mounted display 21 described later. The storage unit 31 stores a user terminal program 39 for processing the system 10, a browser program 37 and an OS 38 (operating system). The user terminal program 39 is stored, for example, in the storage device 33a. By reading the storage device 33a from the connection port 33, the user terminal program 39 is installed in the user terminals 26, 27.

In the hardware configurations of the server device 1, the virtual visitor terminal 26 and the visitor terminal 27 described above, the system functions shown in FIG. 2 are realized using, for example, the CPU 30, the server program 36 and the virtual visitor terminal (visitor terminal) program 39. However, a part or all of the above described configurations may be controlled in sequence using a logic circuit such as a microcomputer or a PLC (Programmable Logic Controller).

### (Hardware Configuration of Head-Mounted Display System 20)

Next, the hardware configuration of the head-mounted display system 20 will be explained. The same reference numerals are assigned to parts of the hardware configuration of the head-mounted display system 20 that are substantially the same as those of the hardware configuration of the virtual visitor terminal 26 described above, and the explanation is omitted.

### (Head-Mounted Display System 20)

Next, the head-mounted display system serving as the virtual visitor terminal 26 will be explained with reference to FIG. 6.

The head-mounted display system 20 shown in the figure includes the head-mounted display 21 to be worn on a user's head and the control device 22. The head-mounted display system 20 described below is one example and is not limited thereto.

### (Head-Mounted Display 21)

The head-mounted display 21 mainly includes a display unit 21a on which images of the virtual space are displayed, and a head position detection sensor 21b. In the present embodiment, the head-mounted display 21 further includes a speaker 21c, a microphone 21d and an operation unit 21e. Note that the speaker 21c, the microphone 21d and the operation unit 21e do not need to be integrated with the head-mounted display 21, but any one of them may be integrated with the head-mounted display 21.

### (Display Unit 21a)

The display unit 21a has left and right image display surfaces arranged at positions corresponding to the left and right eyes, respectively, so as to cover the user's left and right eyes. Three-dimensional images may be presented to the user by displaying images with parallax on the left and right image display surfaces, respectively.

### (Head Position Detection Sensor 21b)

The head position detection sensor 21b detects orientation information such as the direction and tilt of the head-mounted display 21. The sensor for detecting the orientation information is realized by an appropriate combination of a gyro sensor, an acceleration sensor, an angular acceleration sensor and the like. The position and orientation of the user's head are detected, and the detection result is reflected in the three-dimensional image of the virtual space displayed on the display unit 21a, thereby presenting a three-dimensional image (viewpoint image) seen from the viewpoint position corresponding to the movement of the user's head.

### (Speaker 21c, Microphone 21d)

The speaker 21c outputs audio. The speaker 21c outputs real audio within the virtual space, audio/music reflecting the situation in the virtual space, and audio from conversations with the visitor 12 and virtual visitor 13. The user's voice is input to the microphone 21d when conversing with the visitor 12 or virtual visitor 13.

### (Operation Unit 21e)

The operation unit 21e (32a) includes, for example, an operation lever and operation buttons. By operating these, the user can select options displayed on the display unit 21a and perform operations to confirm the selected option. For example, in the present embodiment, a plurality of agricultural products available for purchase in the virtual space is displayed, and the operation unit is used to select the agricultural product to be purchased and to confirm the purchase. By operating the operation unit 21e, the three-dimensional image seen from the viewpoint position can be moved, allowing the user to feel as if they are actually moving within the virtual space. The operation unit 21e is communicably connected to the control device 22 through a communication circuit.

### (Control Device 22)

The hardware configuration of the control device 22 is substantially the same as the hardware configuration of the server device 1 or the virtual visitor terminal 26 described above. Thus, the same reference numerals are assigned to the same parts and the explanation is omitted. The control device 22 performs generation of images and the like to be displayed on the display unit 21a of the head-mounted display 21 and various computation processes.

The storage unit 31 stores processing programs and the like for performing generation of images and the like to be displayed on the display unit 21a and various computation processes.

### 4. Program

### (Flowchart Showing Update Processing)

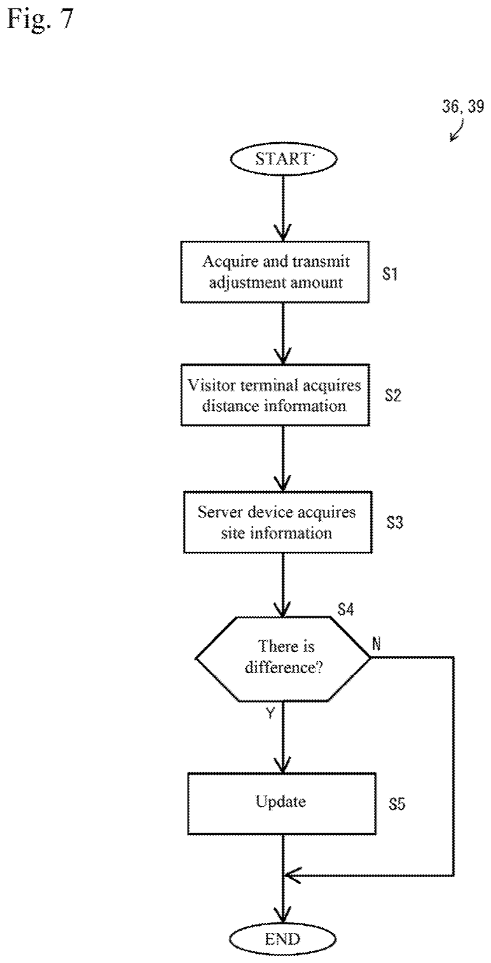

FIG. 7 is a flowchart showing one embodiment of processing by the user terminal program 39 used in the visitor terminal 27 of the system 10 and the server program 36 used in the server device 1 (shown in steps S1 through S4 of FIG. 7).

### (S1: Acquire and Transmit Adjustment Amount)

The server device 1 acquires the adjustment amount 2a based on a predetermined arithmetic expression. The obtained adjustment amount 2a is transmitted to the visitor terminal 27.

The image information 8a and distance information 9a are integrated 3D data (site information 3a). When the distance information 9a extends to deep distances, the amount of 3D data becomes extremely large. This may exceed the possible communication volume between the visitor terminal 27 and the server device 1. Furthermore, if the transmitted site information 3a is large, the amount of computation within the server device 1 overflows. Therefore, the server device 1 judges its own communication capacity load and computational capability of the server device and requests the visitor terminal 27 to suppress the transmission amount of 3D data (comprising image information and distance information).

The processing information 28a and the communication information 28b may also be acquired by executing measurement software installed on the server device 1. The execution may be performed at predetermined time intervals.

Note that other methods of acquiring the adjustment amount 2a may also be used based on the processing speed 28a and the communication speed 28b.

### (Data Structure of Adjustment Amount DB 28)

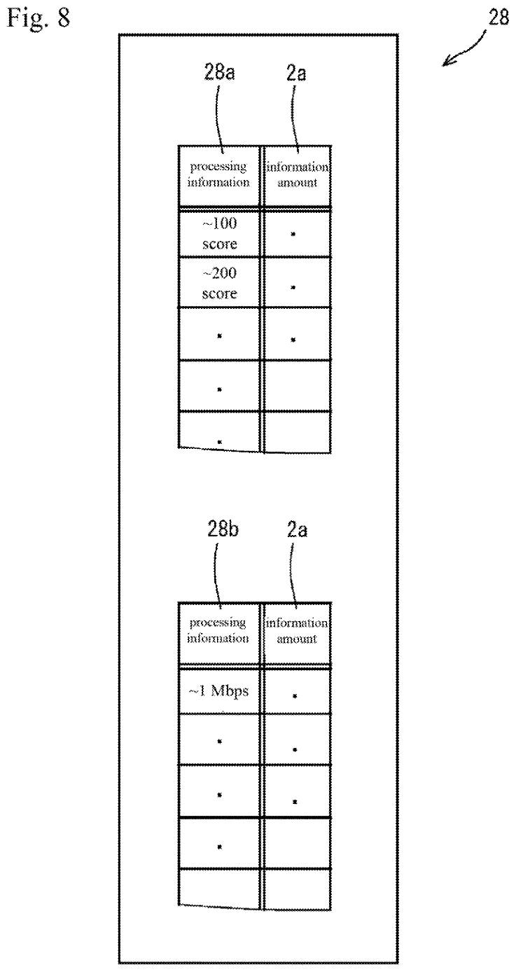

In addition to acquisition by arithmetic expression, the adjustment amount 2a may be acquired using a predetermined table. FIG. 8 shows the data structure of the adjustment amount DB. In the adjustment amount DB 28 shown in the figure, for example, the upper table shows the relationship between the processing information 28a and the adjustment amount 2a, and the lower table shows the relationship between the communication information 28b and the adjustment amount 2a. In both the upper and lower tables, when the processing information 28a and the communication information 28b decrease, the adjustment amount 2a (search depth) becomes shorter. The adjustment amount 2a is obtained from the processing information 28a and the communication information 28b respectively, and the smaller value is adopted as the adjustment amount 2a to be used. Note that the adjustment amount 2a of the adjustment amount DB 28 may be the information amount.

### (S2: Visitor Terminal Acquires Distance Information)

When the visitor terminal 27 acquires the adjustment amount 2a, for example, the distance information acquisition unit 9 retains the distance information 9a equal to or smaller than the adjustment amount 2a and deletes the distance information 9a larger than the adjustment amount 2a. At this time, the position information 7a or the image information 8a corresponding to the distance information 9a to be retained may be retained while others are deleted. The visitor terminal 27 transmits the site information 3a with the reduced information amount to the server device 1.

### (S3: Server Device Acquires Site Information)

Returning to FIG. 7, the server device 1 acquires the site information 3a. The position information 7a is converted into coordinate position information. The feature points are extracted from the spatial data based on the site information 3a and the existing spatial data 25. The coordinates of the respective spatial data are aligned based on the feature points.

### (S4: Determine Difference)

It is determined whether there is a difference between the spatial data based on the site information 3a and the existing spatial data 25. If there is a difference, the differing portion 25a is extracted. On the other hand, if there is no difference, the process ends.

FIG. 9 is a schematic diagram showing differences in the spatial data. The figure shows a vineyard as the event area 11. The upper figure shows the existing spatial data 25. The lower figure shows the spatial data based on the site information 3a. The differing portion 25a (shown as chain double-dashed lines) is shown in the lower figure. In the lower figure, grape berries are growing.

### (S5: Update)

Returning to FIG. 7, the differing portion 25a is replaced/overwritten at the corresponding coordinate position in the existing spatial data 25.

### 5. Other Embodiments

### (Modified Example 40)

Next, modified examples or other embodiments of the system 10 will be explained. Since the system 40 is substantially the same as the system 10 described above, the same reference numerals are assigned to the same parts and the explanation is omitted.

The system 40 does not include the adjustment unit 2 and the determination unit 4 compared to the system 10. The system 40 can, for example, newly generate spatial data 25 by acquiring the site information 3a from a plurality of visitor terminals 27 with the assistance of the visitor 12.

The system 41 does not include the adjustment unit 2 compared to the system 10. Since the system 41 includes the determination unit 4, only the necessary portions can be updated, which is efficient.

### 6. Other Matters

In the head-mounted display system 20 described above, the head-mounted display 21 and the control device 22 may be separate units or may be integrated.

The head-mounted display system 20 does not need to be a dedicated system. For example, the head-mounted display system 20 may be used by attaching a smartphone to a goggle-type headset.

The head-mounted display includes, for example, a Virtual Reality (VR) type head-mounted display on which only a virtual space created by computer graphics or the like is displayed, and a Mixed Reality (MR) type head-mounted display on which a real space (e.g., a real space displayed through optical transparency) and a virtual space are displayed in real time. The present invention can be applied to either type of head-mounted display.

The head-mounted display system 20 may also be used as the visitor terminal 27. In that case, the head-mounted display system 20 serving as the visitor terminal 27 includes the distance information acquisition unit 9. Furthermore, the display unit of the head-mounted display system 20 serving as the visitor terminal 27 may project pre-registered avatar display elements as digital images onto the field of view of the real event area 11 as augmented reality (AR).

The visitor terminal 27 and the virtual visitor terminals 20, 26 may also be made usable as a virtual visitor terminal and a visitor terminal respectively.

Regarding the distance information acquisition unit 9, the output of laser light or radio waves and the sensitivity of the receiving unit may be adjusted to adjust the distance (depth) to be searched.

The adjustment amount 2a is, for example, the distance (depth) to be acquired by the distance information acquisition unit 9 and/or the range over which the distance information is acquired. For example, when the processing information 28a relating to the processing speed of the server device 1 and/or the communication information 28b relating to the communication speed between the server device 1 and the visitor terminal 27 decreases, the adjustment is performed by shortening the distance (depth) to be acquired by the distance information acquisition unit 9 and/or narrowing the range over which the distance information is acquired.

The storage unit 31 of the server device 1 may also store parts (components) for generating spatial images for the spatial data 25. A part or all of the parts may be stored in an external server different from the server device 1. The virtual space processing unit 6 and/or the update unit 5 may acquire the parts to update or generate the spatial data 25.

In the embodiments described above, the server device 1 is used. However, a part or all of the adjustment unit 2, the site information acquisition unit 3, the determination unit 4, the update unit 5, the virtual space processing unit 6 and the storage unit 31 of the server device 1 may be provided in the virtual visitor terminals 20, 26.

As one example, when the virtual visitor terminals 20, 26 are provided with the functions of the server device 1, the spatial data 25 stored in the storage unit 31 of the virtual visitor terminals 20, 26 is updated or generated based on the site information 3a transmitted from the visitor terminal 27.

The matters described as modified examples, other embodiments and other matters in the above embodiments may each be used in appropriate combination.

A part or all of the adjustment unit 2, the site information acquisition unit 3, the determination unit 4, the update unit 5, the virtual space processing unit 6 and the storage unit 31 of the server device 1 may also be provided in the visitor terminal 27. Namely, the server device 1 and the visitor terminal 27 may be configured as an integrated unit. As one example, when the visitor terminal 27 is provided with the functions of the server device 1, the site information acquisition unit 3 of the visitor terminal 27 acquires the site information 3a comprising the spatiotemporal information 7c, the image information 8a and the distance information 9a acquired from the position information acquisition unit 7, the image information acquisition unit 8 and the distance information acquisition unit 9, and the update unit 5 of the visitor terminal 27 updates or generates the spatial data 25 stored in the storage unit 31 of the visitor terminal 27 based on the site information 3a. The updated spatial data 25 is transmitted to the virtual visitor terminal 26 (20) via the communication network 17 and displayed on the display unit 26a (20a) of the virtual visitor terminal 26 (20).

The visitor terminal 27 is not particularly limited as long as it has processing capability to realize the functions of the server device 1. For example, a smartphone, a tablet terminal, a laptop computer, a head-mounted display system 20, smart glasses, AR glasses, an in-vehicle device or a device in which these are integrally configured with an external computing device may be used.

The visitor terminal 27 may also acquire, through communication with another visitor terminal 27, information relating to the range of the site information 3a acquired by another visitor terminal 27 or the coordinate range updated by another visitor terminal 27 in the spatial data 25, and determine the range of the site information 3a to be acquired by the visitor terminal 27 based on coordinate ranges not acquired or not updated by another visitor terminal 27. This allows the plurality of visitor terminals 27 to avoid overlapping acquisition ranges and efficiently update the spatial data 25.

When communication with the server device 1 is disconnected or when the communication speed with the server device 1 falls below a predetermined threshold, the visitor terminal 27 may temporarily accumulate the site information 3a or update differences in the spatial data 25 based on the site information 3a in the storage unit 31 of the visitor terminal 27, and transmit the accumulated information to the server device 1 when communication with the server device 1 is restored or when the communication speed exceeds the predetermined threshold. This enables continued acquisition of the site information 3a even in locations with unstable communication environments.

When the visitor terminal 27 is provided with a part or all of the functions of the server device 1, the visitor terminal 27 may complete the entire process from acquisition of the site information 3a to updating of spatial data 25 within the visitor terminal 27 itself without communicating with the server device 1. This enables highly real-time updating of spatial data 25 without being affected by communication delay.

Furthermore, the visitor terminal 27 may also extract feature points or difference information necessary for updating the spatial data 25 from the image information 8a. The extraction of the feature points can be performed, for example, by using the image information 8a to extract vertices of rectangles. The extraction of the difference information can be performed, for example, by extracting a portion 25a with a predetermined difference using a machine learning model from the spatial data generated from the image information 8a and the existing spatial data 25. In this case, the visitor terminal 27 does not transmit the image information 8a to the server device 1, but transmits only the extracted feature points or difference information to the server device 1. This prevents the captured image information 8a from being output outside the visitor terminal 27, thereby protecting personal information or privacy-related information that may be contained in the image information 8a.

A part of the plurality of visitor terminals 27 may be provided with the functions of the server device 1, and may update or generate the spatial data 25 based on the site information 3a transmitted from another visitor terminal 27. In this case, the visitor terminal 27 provided with the functions of the server device 1 functions as a server device for another visitor terminal 27.

The visitor terminal 27 may be provided with an adjustment unit 2 that makes an adjustment to reduce at least one of the distance and range to be acquired by the distance information acquisition unit 9. The adjustment unit 2 makes the adjustment by reducing the distance (depth) to be acquired by the distance information acquisition unit 9 or narrowing the range over which the distance information 9a is acquired. By reducing the distance or the range over which the distance information 9a is acquired, the amount of data in the site information 3a decreases, and the processing from acquisition of the site information 3a to updating of the spatial data 25 is accelerated. This improves the responsiveness, i.e., the immediacy of updating, until changes in the real-space event area 11 are reflected in the virtual visitor terminal 26 (20).

The adjustment may be performed, for example, in response to a mode selection by an operation of a user of the visitor terminal 27. The adjustment may also be performed in response to a start of a call between the visitor 12 and the virtual visitor 13. At the start of the call, immediacy of updating is required because information needs to be shared in real time between the visitor 12 and the virtual visitor 13. Furthermore, the adjustment may be performed in response to a decrease in processing information 28a relating to the processing speed of the visitor terminal 27, or a decrease in communication information 28b relating to the communication speed with the virtual visitor terminal 26 (20).

As one example, the adjustment unit 2 of the visitor terminal 27 switches between a first mode in which at least one of the distance (depth) and the range for acquiring the distance information 9a is made relatively larger, and a second mode in which at least one is made relatively smaller. In the first mode, the distance information acquisition unit 9 acquires the distance information 9a up to the maximum available distance (depth), and a wider target space is grasped, including the site information 3a acquired while the visitor 12 moves. In the second mode, at least one of the distance (depth) and the range for acquiring the distance information 9a is narrowed, and the process from acquisition of the site information 3a to updating of spatial data 25 is performed immediately and dynamically. This allows the second mode to be used in situations where immediacy of updating is required, such as a call between the visitor 12 and the virtual visitor 13, and the first mode to be used in situations where a wide grasp of the target space is required. Namely, the visitor terminal 27 adjusts at least one of the distance and the range for acquiring the distance information 9a by balancing the immediacy of updating with the grasp range of the target space.

The adjustment unit 2 of the visitor terminal 27 may also autonomously adjust at least one of the distance and the range to be acquired by the distance information acquisition unit 9 based on terminal state information relating to the state of the visitor terminal 27 itself. The terminal state information includes, for example, the CPU 30 usage rate of the visitor terminal 27, the usage rate of the storage unit 31, the remaining battery level, the temperature of the CPU 30, the available storage capacity, the radio signal strength of wireless communication, and the communication speed of the communication circuit 34. As one example, when the remaining battery level of the visitor terminal 27 falls to or below a predetermined threshold, the adjustment unit 2 of the visitor terminal 27 makes an adjustment to shorten the distance (depth) to be acquired by the distance information acquisition unit 9 and/or narrow the range over which the distance information 9a is acquired. The adjustment unit 2 of the visitor terminal 27 also makes the same adjustment when the usage rate of the CPU 30 or the usage rate of the storage unit 31 of the visitor terminal 27 reaches or exceeds a predetermined threshold. Furthermore, the adjustment unit 2 of the visitor terminal 27 makes the same adjustment when the temperature of the CPU 30 of the visitor terminal 27 reaches or exceeds a predetermined threshold. This enables the visitor terminal 27 to acquire the site information 3a necessary for updating the spatial data 25 within the range of the visitor terminal 27's own processing capability without receiving instructions from the server device 1.

### 7. Summary

The server device 1 is a server device that updates spatial data 25 of a virtual space having coordinates corresponding to positions in the real space, based on image information 8a obtained from the user terminal 27 of a visitor to the real space that acquires time information 7b and position information 7a, the server device 1 comprising: a site information acquisition unit 3 that acquires a site information 3a comprising spatiotemporal information 7c, image information 8a corresponding to the spatiotemporal information and distance information 9a to a target object corresponding to the image information; and an update unit 5 that generates/updates the spatial data 25 based on the site information.

Therefore, the spatial data 25 can be newly generated or updated by acquiring the site information 3a from a plurality of visitor terminals 27 with the assistance of the visitor 12.

Furthermore, the closer the virtual visitor 13 approaches the vicinity of the visitor 12 in the virtual space, the virtual visitor 13 can see the spatial data 25 updated by the visitor terminal 27. This enables the virtual visitor 13 to experience phenomena occurring in the real world at that moment with the assistance of the real visitor 12.

The above described server device 1 includes a determination unit 4 for determining whether or not there is a predetermined difference with respect to the spatial data 25 corresponding to the site information 3a. When the difference exists, the differing portion 25a of the spatial data 25 is updated so that only the necessary portions can be updated, which is efficient.

Furthermore, since no update is performed when there is no difference, the process is even more efficient.

Furthermore, since the server device 1 includes the adjustment unit 2 that adjusts the information amount 2a of the distance information 9a to be acquired in accordance with the processing information 28a relating to the processing speed of the server device 1 and/or the communication information 28b relating to the communication speed between the server device 1 and the user terminals 26, 27, a practical virtual space in a digital twin can be constructed by synthesizing, in real time or nearly real time, the necessary portion at hand of the virtual visitor 13 and the overall general image of the entire space, through partial and continuous updating of the range to be updated by the plurality of the visitor 12 in the real space.

In addition, the visitor terminal 27 is a visitor terminal 27 for updating spatial data 25 of a virtual space having coordinates corresponding to positions in the real space, the visitor device 27 being held by a visitor in an event area of the real space, the visitor device 27 comprising: a site information acquisition unit 3 configured to acquire site information 3a, the site information 3a comprising: spatiotemporal information 7c including time information 7b and position information 7a; image information 8a corresponding to the spatiotemporal information 7c; and distance information 9a from the visitor terminal 27 to a target object corresponding to the image information 8a; and an update unit 5 configured to update, based on the field information 3a, the spatial data among the spatial data 25 that corresponds to the field information 3a, wherein an event area 14 of the virtual space that has been updated is displayed on a display unit 26a (20a) of a virtual visitor terminal 26 (20) held by a virtual visitor 13 visiting the virtual space. Therefore, by providing the visitor terminal 27 with a part or all of the functions of the server device 1, communication between the visitor terminal 27 and the server device 1 can be reduced or eliminated, making the system less susceptible to the effects of communication delay, and enabling updating of the spatial data 25 even in locations where the communication environment is insufficient.

In addition, the visitor terminal 27 is a visitor terminal 27 for updating spatial data 25 of a virtual space having coordinates corresponding to positions in a real space, the visitor device comprising: a site information acquisition unit 3 configured to acquire site information 3a comprising spatiotemporal information 7c including time information 7b and position information 7a, image information 8a corresponding to the spatiotemporal information 7c and distance information 9a to a target object corresponding to the image information 8a; an update unit 5 configured to update the spatial data 25 based on the field information 3a; and an adjustment unit 2 configured to make an adjustment to reduce a distance to be acquired and/or a range over which the distance information 9a is acquired when processing information 28a relating to the processing speed of the visitor terminal 27 and/or communication information 28b relating to the communication speed with a virtual visitor terminal 26 (20) held by a virtual visitor 13 visiting the virtual space decreases. Therefore, the range or distance of the distance information 9a to be acquired can be adjusted according to the processing speed of the visitor terminal 27 itself and the communication speed with the virtual visitor terminal 26 (20), enabling efficient updating of the spatial data 25 according to the processing capability and communication status of the visitor terminal 27.

In addition, since the distance information 9a is acquired using a LiDAR sensor, the distance to the object can be acquired with high precision.

In addition, since the visitor terminal 27 is provided with a determination unit 4 configured to determine whether or not there is a difference between spatial data corresponding to the field information 3a and the existing spatial data 25, and when the difference exists, updates the differing portion 25a of the existing spatial data 25, only the necessary portions can be updated, making it efficient.

In addition, since the visitor terminal 27 acquires, through communication with another visitor terminal 27, information relating to the range of field information 3a acquired by another visitor terminal 27 or the coordinate range updated by another visitor terminal 27 in the spatial data 25, and determines the range of field information 3a to be acquired by the visitor terminal 27 itself, based on coordinate ranges not acquired or not updated by the other visitor terminal 27, the plurality of visitor terminals 27 can avoid overlapping acquisition ranges and efficiently update the spatial data 25.

In addition, since the visitor terminal 27 extracts feature points or difference information necessary for updating the spatial data 25 from the image information 8a, and transmits only the extracted feature points or difference information to the server device 1 without transmitting the image information 8a to the server device 1, the captured image information 8a is not output outside the visitor terminal 27, thereby protecting personal information or privacy-related information that may be contained in the image information 8a.

In addition, since the visitor terminal 27 is provided with an adjustment unit 2 configured to make an adjustment to reduce the distance and/or range for acquiring the distance information 9a based on a mode selection by an operation of a user of the visitor terminal 27, a start of a call between the visitor 12 and the virtual visitor 13, a decrease in processing information 28a or a decrease in communication information 28b, the grasp range of the target space and the immediacy of updating can be balanced according to the intention of the user of the visitor terminal 27, the initiation of a call, the processing status of the visitor terminal 27, or the communication status.

In addition, since the adjustment unit 2 of the visitor terminal 27 makes an adjustment to reduce the distance and/or range for acquiring the distance information 9a, also based on a mode selection by an operation of a user of the visitor terminal 27 or a start of a call between the visitor 12 and the virtual visitor 13, the immediacy of updating can be enhanced in response to the intention of the user of the visitor terminal 27 and the event of the start of a call.

### DESCRIPTION OF THE REFERENCE NUMERALS

1: server device, 2: adjustment unit, 2a: information amount (adjustment amount), 3: site information acquisition unit 3a: site information, 4: determination unit, 5: update unit, 6: virtual space processing unit, 6a: operation information, 7: position information acquisition unit, 7a: position information, 7b: time information, 7c: spatiotemporal information, 8: image information acquisition unit, 8a: image information, 9: distance information acquisition unit, 9a: distance information, 10: virtual space update system, 11: event area, 12: visitor, 12a: avatar display element, 13: remote person (virtual visitor), 13a: avatar display element, 14: virtual-space event area, 17: communication network, 18: event-related products, 20: head-mounted display system, 21: head-mounted display, 22: control device, 24: surrounding camera, 25: spatial data, 26: user terminal (remote person/virtual visitor terminal), 26a: display unit of virtual visitor, 27: user terminal (visitor terminal), 27a: display unit of visitor terminal, 28: adjustment amount database (adjustment amount DB), 28a: processing information, 28b: communication information, 30: CPU, 31: memory, 32: input/output device, 32a: operation unit, 33: connection port, 33a: storage device, 34: communication circuit, 35: bus line, 36: server program, 37: browser program, 38: OS, 39: terminal program, 40: modified example, 41: modified example

1. A server device for updating spatial data of a virtual space having coordinates corresponding to positions in a real space, the server device comprising:
a site information acquisition unit configured to acquire site information obtained from a visitor terminal held by a visitor in an event area of the real space, the site information comprising: spatiotemporal information including time information and position information;
image information corresponding to the spatiotemporal information; and distance information from the visitor terminal to a target object corresponding to the image information; and
an update unit configured to update the spatial data corresponding to the site information based on the site information among the spatial data, wherein
the visitor terminal is communicably connected to a virtual visitor terminal held by a virtual visitor visiting the virtual space and an updated event area of the virtual space is displayed on a display unit of the virtual visitor terminal.

2. The server device according to claim 1, wherein the distance information is acquired using a LiDAR sensor.

3. The server device according to claim 1, further comprising:
a determination unit configured to determine whether or not there is a difference between the spatial data corresponding to the site information and an existing spatial data, wherein
when the difference exists, a portion of the existing spatial data having the difference is updated.

4. A server device for updating spatial data of a virtual space having coordinates corresponding to positions in a real space, the server device comprising:
a site information acquisition unit configured to acquire site information obtained from a visitor terminal held by a visitor in the real space, the site information comprising:
spatiotemporal information including time information and position information; image information corresponding to the spatiotemporal information; and distance information from the visitor terminal to a target object corresponding to the image information;
an update unit configured to update the spatial data based on the site information; and
an adjustment unit configured to make an adjustment to reduce a distance to be acquired and/or a range over which the distance information is acquired when processing information relating to a processing speed of the server device and/or communication information relating to a communication speed with the visitor terminal decreases.

5. The server device according to claim 1, wherein
the spatial data is updated at predetermined time intervals by a surrounding camera installed in the real space.

6. The server device according to claim 5, wherein the surrounding camera updates the spatial data using a Lidar sensor.

7. A visitor terminal for updating spatial data of a virtual space having coordinates corresponding to positions in a real space, the visitor terminal being held by a visitor in an event area of the real space, the visitor device comprising:
a site information acquisition unit configured to acquire site information, the site information comprising: spatiotemporal information including time information and position information; image information corresponding to the spatiotemporal information; and distance information from the visitor terminal to a target object corresponding to the image information; and
an update unit configured to update the spatial data corresponding to the site information based on the site information among the spatial data, wherein
an updated event area of the virtual space is displayed on a display unit of a virtual visitor terminal held by a virtual visitor visiting the virtual space.

8. A visitor terminal for updating spatial data of a virtual space having coordinates corresponding to positions in a real space, the visitor device comprising:
a site information acquisition unit configured to acquire site information, the site information comprising: spatiotemporal information including time information and position information; image information corresponding to the spatiotemporal information; and distance information to a target object corresponding to the image information;
an update unit configured to update the spatial data based on the site information; and
an adjustment unit configured to make an adjustment to reduce a distance to be acquired and/or a range over which the distance information is acquired when processing information relating to a processing speed of the server device and/or communication information relating to a communication speed with the visitor terminal held by a virtual visitor visiting the virtual space decreases.

9. The visitor terminal according to claim 7, further comprising:
an adjustment unit configured to make an adjustment to reduce a distance to be acquired and/or a range over which the distance information is acquired based on a mode selection by an operation of a user of the visitor terminal, a start of a call between the visitor and the virtual visitor, a decrease in processing information relating to a processing speed of the visitor terminal, or a decrease in communication information relating to a communication speed with the virtual visitor terminal.

10. The visitor terminal according to claim 8, wherein
the adjustment unit is configured to make the adjustment to reduce the distance to be acquired and/or the range in which the distance information is acquired also based on a mode selection by an operation of a user of the visitor terminal or a start of a call between the visitor and the virtual visitor.
